(19) United States
(12) Patent Application Publication
(10) Pub. No.: US 2025/0388710 A1
(43) Pub. Date: Dec. 25, 2025

(54) Encapsulant and Encapsulation Film Formed From the Same

(71) Applicant: Ming Chi University of Technology, New Taipei City (TW)

(72) Inventors: Yu-Ching Huang, New Taipei City (TW); Wei-Fang Su, New Taipei City (TW); Chieh-Ming Tsai, Kaohsiung City (TW)

(21) Appl. No.: 18/940,903

(22) Filed: Nov. 8, 2024

(30) Foreign Application Priority Data
Jun. 25, 2024 (TW) 113123634

(51) Int. Cl. C08F 214/26; C08F 2/48; C08F 216/12; C08F 220/22; C08F 222/10; C08J 5/18; C08K 3/36; C08K 5/09; C08K 9/06; C08L 27/18

(52) U.S. Cl. CPC C08F 214/26; C08F 2/48; C08F 216/12; C08F 220/22; C08F 222/102; C08J 5/18; C08K 3/36; C08K 5/09; C08K 9/06; C08L 27/18; C08J 2327/14; C08J 2329/10; C08K 2201/011; C08L 2203/16; C08L 2203/206; C08L 2312/06

(57) ABSTRACT

An encapsulant includes a cross-linked polymer, an acrylate component, and a photoinitiator. The cross-linked polymer is formed by subjecting a vinyl fluoride-vinyl ether copolymer to a cross-linking reaction with a tetracarboxylic dianhydride. The vinyl fluoride-vinyl ether copolymer has a weight-average molecular weight ranging from 10000 to 50000, and a hydroxyl value ranging from 40 mg KOH/g to 170 mg KOH/g. The tetracarboxylic dianhydride is represented by formula (I)

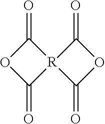

(I). R represents a tetravalent organic group containing fluorine and an aromatic group. The acrylate component includes an acrylate monomer selected from a monoacrylate monomer, a monomethacrylate monomer, a diacrylate monomer, a dimethacrylate monomer, a triacrylate monomer, a trimethacrylate monomer, and combinations thereof.

### CROSS-REFERENCE TO RELATED APPLICATION

This application claims priority to Taiwanese Patent Application No. 113123634, filed on Jun. 25, 2024, the disclosure of which is incorporated by reference in its entirety.

### BACKGROUND OF THE DISCLOSURE

### Field of the Disclosure

The disclosure relates to an encapsulant and an encapsulation film formed from the same.

### Description of Related Art

Since a perovskite solar cell is susceptible to environmental factors such as humidity, which may cause a reduction in service life thereof, an encapsulation film is generally provided in the perovskite solar cell to minimize an impact of humidity thereon, so as to allow the perovskite solar cell to have a long service life. A good encapsulation film not only needs to have a low water vapor permeability (WVP), but also should not react with a perovskite in the perovskite solar cell.

### SUMMARY OF THE DISCLOSURE

Accordingly, in a first aspect, the present disclosure provides an encapsulant, which can alleviate at least one of the drawbacks of the prior art. The encapsulant includes:
a cross-linked polymer formed by subjecting a vinyl fluoride-vinyl ether copolymer to a cross-linking reaction with a tetracarboxylic dianhydride, the vinyl fluoride-vinyl ether copolymer having a weight-average molecular weight ranging from 10000 to 50000, and a hydroxyl value ranging from 40 mg KOH/g to 170 mg KOH/g, the tetracarboxylic dianhydride being represented by formula (I)

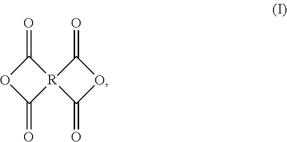

wherein R represents a tetravalent organic group containing fluorine and an aromatic group;
an acrylate component including an acrylate monomer selected from the group consisting of a monoacrylate monomer, a monomethacrylate monomer, a diacrylate monomer, a dimethacrylate monomer, a triacrylate monomer, a trimethacrylate monomer, and combinations thereof; and
a photoinitiator.

In a second aspect, the present disclosure provides an encapsulation film, which can alleviate at least one of the drawbacks of the prior art. The encapsulation film is formed by subjecting the aforesaid encapsulant to a photo-curing reaction.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 shows the Fourier-transform infrared (FTIR) spectra of a vinyl fluoride-vinyl ether copolymer, a tetracarboxylic dianhydride, and a cross-linked polymer of Example 1.

FIG. 2 shows the FTIR spectra of silica nanoparticles and modified silica nanoparticles of Example 12.

FIG. 3 is a data graph illustrating normalized efficiencies of a perovskite solar cell, which includes an encapsulation film formed from an encapsulant of Example 19, during an accelerated life testing.

### DESCRIPTION OF NON-LIMITING EMBODIMENTS OF THE DISCLOSURE

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides an encapsulant which includes a cross-linked polymer, an acrylate component, and a photoinitiator.

According to the present disclosure, the cross-linked polymer is formed by subjecting a vinyl fluoride-vinyl ether copolymer to a cross-linking reaction with a tetracarboxylic dianhydride.

The term “vinyl fluoride” refers to a fluorine-containing ethylene, e.g., tetrafluoroethylene or chlorotrifluoroethylene. The term “vinyl fluoride-vinyl ether copolymer” refers to a polymer formed by subjecting the fluorine-containing ethylene and a vinyl ether compound to a copolymerization reaction. The vinyl fluoride-vinyl ether copolymer has a weight-average molecular weight ranging from 10000 to 50000. The vinyl fluoride-vinyl ether copolymer has hydroxyl groups, and has a hydroxyl value ranging from 40 mg KOH/g to 170 mg KOH/g. In certain embodiments, the vinyl fluoride-vinyl ether copolymer may be selected from the group consisting of a tetrafluoroethylene-vinyl ether copolymer, a chlorotrifluoroethylene-vinyl ether copolymer, and a combination thereof. In an exemplary embodiment, the vinyl fluoride-vinyl ether copolymer is the tetrafluoroethylene-vinyl ether copolymer. Examples of the vinyl fluoride-vinyl ether copolymer may include, but are not limited to, a commercially available product selected from the group consisting of ZEFFLE® GK570, which is available from Daikin Industries, Ltd. (Japan) (hereinafter abbreviated as “DAIKIN (Japan)”), LUMIFLON® LF-600X, LUMIFLON® LF-9716, LUMIFLON® LF-9721, LUMIFLON® LF200, LUMIFLON® LF200F, LUMIFLON® LF710F, LUMIFLON® LF910LM, LUMIFLON® LF916F, which are available from Asahi Glass Co., Ltd. (Japan) (hereinafter abbreviated as “AGC (Japan)”), and combinations thereof. In certain embodiments, the commercially available product serving as the vinyl fluoride-vinyl ether copolymer may be selected from the group consisting of ZEFFLE® GK570 available from DAIKIN (Japan), LUMIFLON® LF200 available from AGC (Japan), and a combination thereof. In an exemplary embodiment, the commercially available product serving as the vinyl fluoride-vinyl ether copolymer is ZEFFLE® GK570 available from DAIKIN (Japan).

According to the present disclosure, the tetracarboxylic dianhydride is represented by formula (I)

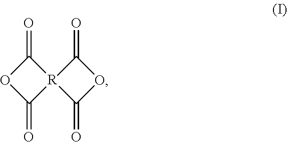

wherein R represents a tetravalent organic group containing fluorine and an aromatic group.

In certain embodiments, the tetracarboxylic dianhydride may be selected from the group consisting of a chemical compound represented by formula (II) (hereinafter abbreviated as “FIDA”), 4,4′-(hexafluoroisopropylidene)diphthalic anhydride (6FDA), and a combination thereof,

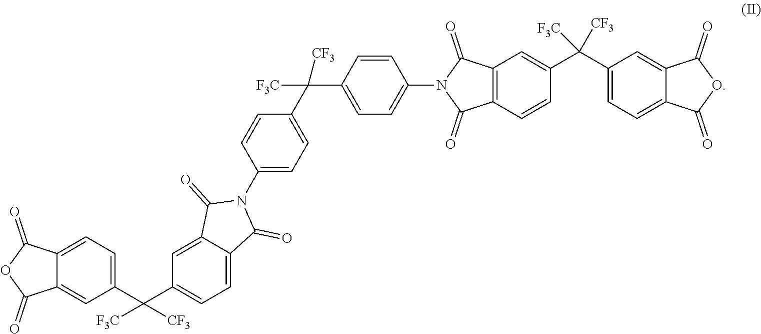 [SMILES: O=C1OC(=O)c2cc(C(c3ccc4c(c3)C(=O)N(c3ccc(C(c5ccc(N6C(=O)c7ccc(C(c8ccc9c(c8)C(=O)OC9=O)(C(F)(F)F)C(F)(F)F)cc7C6=O)cc5)(C(F)(F)F)C(F)(F)F)cc3)C4=O)(C(F)(F)F)C(F)(F)F)ccc21]

In an exemplary embodiment, the tetracarboxylic dianhydride is the FIDA.

A weight amount ratio of the vinyl fluoride-vinyl ether copolymer to the tetracarboxylic dianhydride is not particularly limited, and may be adjusted according to practical requirements. In some embodiments, the weight amount ratio of the vinyl fluoride-vinyl ether copolymer to the tetracarboxylic dianhydride may be adjusted according to a molar ratio of a total amount of the hydroxyl groups of the vinyl fluoride-vinyl ether copolymer to a total amount of anhydride groups of the tetracarboxylic dianhydride. For example, the weight amount ratio of the vinyl fluoride-vinyl ether copolymer to the tetracarboxylic dianhydride may be adjusted to allow the molar ratio of the total amount of the hydroxyl groups of the vinyl fluoride-vinyl ether copolymer to the total amount of the anhydride groups of the tetracarboxylic dianhydride to be within a range from 0.5 to 2 in decimal form. In an exemplary embodiment, the weight amount ratio of the vinyl fluoride-vinyl ether copolymer to the tetracarboxylic dianhydride may be adjusted to allow the molar ratio of the total amount of the hydroxyl groups of the vinyl fluoride-vinyl ether copolymer to the total amount of the anhydride groups of the tetracarboxylic dianhydride to be 1 in decimal form.

According to the present disclosure, the cross-linking reaction may be performed under a nitrogen atmosphere at 75° C. In some embodiments, the cross-linked polymer may be formed by subjecting a copolymer solution containing the vinyl fluoride-vinyl ether copolymer and a first solvent to the cross-linking reaction with an anhydride solution containing the tetracarboxylic dianhydride and a second solvent. An example of the first solvent may include, but is not limited to, ethyl acetate, which is used to dissolve the vinyl fluoride-vinyl ether copolymer. An example of the second solvent may include, but is not limited to, ethyl acetate, which is used to dissolve the tetracarboxylic dianhydride. As a result, a polymerization product obtained after the cross-linking reaction not only includes the cross-linked polymer, but also the first solvent and the second solvent.

According to the present disclosure, the acrylate component includes an acrylate monomer selected from the group consisting of a monoacrylate monomer, a monomethacrylate monomer, a diacrylate monomer, a dimethacrylate monomer, a triacrylate monomer, a trimethacrylate monomer, and combinations thereof. In certain embodiments, the monoacrylate monomer may be selected from the group consisting of 2-phenoxyethyl acrylate (PEA), 1H, 1H,7H-dodecafluoroheptyl acrylate (12FHA), and a combination thereof. In certain embodiments, the diacrylate monomer may be selected from the group consisting of neopentyl glycol diacrylate (NPGDA), 1,6-hexanediol diacrylate (HDDA), and a combination thereof. In certain embodiments, the triacrylate monomer may be trimethylolpropane triacrylate (TMPTA). In some embodiments, the acrylate component may include only one type of acrylate monomer. For example, the acrylate monomer may be the diacrylate monomer selected from the NPGDA or the HDDA. In other embodiments, the acrylate component may include more than two types of acrylate monomers mixed in a desired proportion. For instance, the acrylate component may include a combination of the NPGDA and the 12FHA, a combination of the NPGDA and the HDDA, or a combination of the 12FHA and the HDDA.

A weight amount ratio of the cross-linked polymer to the acrylate component is not particularly limited, and can be adjusted according to practical requirements. In certain embodiments, based on a total amount of the cross-linked polymer and the acrylate component as 100 wt %, the cross-linked polymer may be present in an amount ranging from 20 wt % to 80 wt %, and the acrylate component may be present in an amount ranging from 20 wt % to 80 wt %. In an exemplary embodiment, based on the total amount of the cross-linked polymer and the acrylate component as 100 wt %, the cross-linked polymer is present in an amount of 30 wt %, and the acrylate component is present in amount of 70 wt %.

In some embodiments, when the acrylate component includes the diacrylate monomer selected from the NPGDA or the HDDA, the acrylate component may be present in an amount of 70 wt % based on the total amount of the cross-linked polymer and the acrylate component as 100 wt %, and an encapsulation film made from the encapsulant including the acrylate component present in such amount (i.e., 70 wt %) has a relatively low water-vapor permeability (WVP) value and a relatively high visible light transmittance. In still some embodiments, when the acrylate component includes the combination of the HDDA and the 12FHA, the HDDA may be present in an amount ranging from 50 wt % to 65 wt % and the 12FHA may be present in an amount ranging from 5 wt % to 20 wt % based on the total amount of the cross-linked polymer and the acrylate component as 100 wt %, and an encapsulation film made from the encapsulant including the acrylate component present in such amount [i.e., the aforesaid amounts of the HDDA (from 50 wt % to 65 wt %) and the 12FHA (from 5 wt % to 20 wt %)] has a relatively low WVP value and a relatively high visible light transmittance. In yet some embodiments, when the acrylate component includes the combination of the NPGDA and the HDDA, the NPGDA may be present in an amount ranging from 17.5 wt % to 52.5 wt % and the HDDA may be present in an amount ranging from 17.5 wt % to 52.5 wt % based on the total amount of the cross-linked polymer and the acrylate component as 100 wt %, and an encapsulation film made from the encapsulant including the acrylate component present in such amount [i.e., the aforesaid amounts of the NPGDA (from 17.5 wt % to 52.5 wt %) and the HDDA (from 17.5 wt % to 52.5 wt %)] has a relatively low WVP value and a relatively high visible light transmittance. In still yet some embodiments, when the acrylate component includes the combination of the NPGDA and the 12FHA, the NPGDA may be present in an amount ranging from 50 wt % to 65 wt % and the 12FHA may be present in an amount ranging from 5 wt % to 20 wt % based on the total amount of the cross-linked polymer and the acrylate component as 100 wt %, and an encapsulation film made from the encapsulant including the acrylate component present in such amount [i.e., the aforesaid amounts of the NPGDA (from 50 wt % to 65 wt %) and the 12FHA (from 5 wt % to 20 wt %)] has a relatively high visible light transmittance.

According to the present disclosure, by virtue of the photoinitiator, the cross-linked polymer and the acrylate component can undergo a photo-curing reaction carried out under irradiation. The photoinitiator may be a commonly used photoinitiator such as 1-hydroxycyclohexyl phenyl ketone, but is not limited thereto. In an exemplary embodiment, the photoinitiator is 1-hydroxycyclohexyl phenyl ketone. The amount of the photoinitiator is not particularly limited, and may be flexibly adjusted according to the total amount of the cross-linked polymer and the acrylate component.

Since the polymerization product obtained after the cross-linking reaction also includes the first solvent and the second solvent, the first solvent and the second solvent may be removed at any time during preparation of the encapsulant, so as to allow the encapsulant to be substantially solvent-free. In some embodiments, removal of the first solvent and the second solvent may be conducted after mixing of the polymerization product, the acrylate component, and the photoinitiator.

According to the present disclosure, the encapsulant may further include an organic-inorganic composite material selected from the group consisting of modified silica nanoparticles, acryloyl silica particles, and a combination thereof.

In certain embodiments, the modified silica nanoparticles may be formed by subjecting silica nanoparticles to a surface modification treatment with an acryloyl alkoxysilane. In certain embodiments, the acryloyl alkoxysilane may be selected from the group consisting of a monoacryloyl alkoxysilane, a monomethacryloyl alkoxysilane, a bisacryloyl alkoxysilane, a dimethacryloyl alkoxysilane, and combinations thereof. In an exemplary embodiment, the acryloyl alkoxysilane is the monoacryloyl alkoxysilane. An example of the monoacryloyl alkoxysilane may include, but is not limited to, 3-methacryloxypropyltrimethoxysilane (MPS). In certain embodiments, the monoacryloyl alkoxysilane may be the MPS. Moreover, the silica nanoparticles may have an average particle size of 25 nm, but the average particle size thereof is not particularly limited. A weight amount ratio of the acryloyl alkoxysilane to the silica nanoparticles is not particularly limited, and may be adjusted according to practical requirements. In certain embodiments, the method for preparing the modified silica nanoparticles may include subjecting a suspension containing the silica nanoparticles and a dispersion medium to the surface modification treatment with the acryloyl alkoxysilane, thereby obtaining a first composite additive, which not only includes the modified silica nanoparticles, but also the dispersion medium. An example of the dispersion medium of the suspension may include, but is not limited to, methanol. The silica nanoparticles may be present in an amount of 40 wt % based on 100 wt % of the suspension, but the amount thereof is not particularly limited. The surface modification treatment may be performed in a reflux system at 50° C., but conditions for performing the surface modification treatment is not particularly limited.

In certain embodiments, the acryloyl silica particles may be formed by subjecting an acryloyl alkoxysilane to a hydrolysis-condensation reaction. The acryloyl silica particles have acryloyl groups. In certain embodiments, the acryloyl alkoxysilane may be selected from the group consisting of a monoacryloyl alkoxysilane, a monomethacryloyl alkoxysilane, a bisacryloyl alkoxysilane, a dimethacryloyl alkoxysilane, and combinations thereof. In some embodiments, the acryloyl silica particles may be formed by subjecting the monoacryloyl alkoxysilane to the hydrolysis-condensation reaction. In some exemplary embodiments, the monoacryloyl alkoxysilane is the MPS, and the acryloyl silica particles are formed by subjecting the MPS to the hydrolysis-condensation reaction. In certain embodiments, the method for preparing the acryloyl silica particles may include subjecting the acryloyl alkoxysilane to the hydrolysis-condensation reaction with an alcohol solvent, thereby obtaining a second composite additive, which not only includes the acryloyl silica particles, but also the alcohol solvent. The alcohol solvent may be, for example, methanol, but is not particularly limited. The hydrolysis-condensation reaction may be performed in a reflux system at 50° C., but conditions for performing the hydrolysis-condensation reaction is not particularly limited. In an exemplary embodiment, the organic-inorganic composite material of the encapsulant is the acryloyl silica particles, and an encapsulation film made from such encapsulant has a relatively high visible light transmittance.

A weight amount ratio of the organic-inorganic composite material in the encapsulant is not particularly limited, and may be adjusted according to practical requirements. In certain embodiments, based on a total amount of the cross-linked polymer, the acrylate component, and the organic-inorganic composite material as 100 wt %, the cross-linked polymer may be present in an amount ranging from 20 wt % to 50 wt %, the acrylate component may be present in an amount ranging from 20 wt % to 70 wt %, and the organic-inorganic composite material may be present in an amount ranging from 10 wt % to 50 wt %. In certain embodiments, based on the total amount of the cross-linked polymer, the acrylate component, and the organic-inorganic composite material as 100 wt %, the cross-linked polymer may be present in an amount ranging from 20 wt % to 23 wt %, the acrylate component may be present in an amount ranging from 29 wt % to 51 wt %, and the organic-inorganic composite material may be present in an amount ranging from 27 wt % to 50 wt %, and an encapsulation film made from such encapsulant with the aforesaid amounts of the cross-lined polymer, the acrylate component, and the organic-inorganic composite material has a relatively low WVP value.

According to the present disclosure, the first solvent and the second solvent in the polymerization product, the alcohol solvent in the second composite additive, and the dispersion medium in the first composite additive may be removed at any time during preparation of the encapsulant, so as to allow the encapsulant to be substantially free from the first solvent, the second solvent, the alcohol solvent, and the dispersion medium. In some embodiments, removal of the first solvent, the second solvent, the alcohol solvent, and the dispersion medium may be conducted after mixing of the polymerization product, the acrylate component, the photoinitiator, and the first composite additive or the second composite additive.

The present disclosure also provides an encapsulation film, which is formed by subjecting the aforesaid encapsulant to a photo-curing reaction.

The present disclosure will be further described by way of the following examples. However, it should be understood that the following examples are intended solely for the purpose of illustration and should not be construed as limiting the present disclosure in practice.

### Preparation of Encapsulation Film

### Example 1

First, 3.08 g of a solution containing vinyl fluoride-vinyl ether copolymer and butyl acetate (DAIKIN, Japan; ZEFFLE® GK570) was heated at 90° C. for 2 hours, so as to remove the butyl acetate. Next, the vinyl fluoride-vinyl ether copolymer was dissolved in 12 mL of ethyl acetate, followed by stirring for 1 hour, so as to form a copolymer solution. Thereafter, 1.6 g of FIDA (serving as a tetracarboxylic dianhydride) was dissolved in 10 mL of ethyl acetate, so as to form an anhydride solution. After that, the copolymer solution was subjected to a cross-linking reaction with the anhydride solution at 75° C. under a nitrogen atmosphere for 48 hours, so as to form a polymerization product which included the ethyl acetate and a cross-linked polymer.

Subsequently, the polymerization product was mixed with neopentyl glycol diacrylate (NPGDA, a diacrylate monomer serving as an acrylate component) (TCI Co., Ltd.; purity: 89%), so as to obtain a raw material. The raw material and a photoinitiator (Ciba-Geigy; Model: Irgacure 184) were then mixed in a weight ratio of 100:4, followed by removing the ethyl acetate using an air exhauster (Vacuumer; Model: VOP-100), thereby obtaining an encapsulant. The encapsulant was stored in a sample bottle wrapped with an aluminum foil for later use. In the encapsulant, based on a total amount of the cross-linked polymer and the acrylate component as 100 wt %, the cross-linked polymer was present in an amount of 30 wt %, and the acrylate component was present in an amount of 70 wt %.

Thereafter, the encapsulant was filled into a hollow mold with a hollow space having a diameter of 5 cm and a thickness of 100 μm, and then the hollow mold was sandwiched between two polyethylene terephthalate (PET) films, followed by using a glass rod to press one of the PET films along a direction parallel to a surface of the hollow mold, so that an excess amount of the encapsulant in the hollow space of the hollow mold was squeezed out of the hollow mold. Subsequently, the encapsulant that remained in the hollow space of the hollow mold was subjected to a photo-curing reaction for 2 minutes using a high-power ultraviolet lamp (OPAS, Model: Xlite 400Q), so that the encapsulant remaining in the hollow space of the hollow mold was formed into an encapsulation film with a thickness of 100 μm, followed by removing one of the PET films and demoulding the encapsulation film from the hollow mold, thereby obtaining the encapsulation film of Example 1.

### Examples 2 to 11

The procedures for preparing an encapsulation film of each of Examples 2 to 11 were similar to those of Example 1, except that the type and amount of the acrylate component were varied as shown in Tables 1 and 2 below. Briefly, any one of NPGDA, 1,6-hexanediol diacrylate (HDDA) (TCI Co., Ltd.; purity: 98.0%), and 1H,1H,7H-dodecafluoroheptyl acrylate (12FHA) (TCI Co., Ltd.; purity: 97.0%), or any one of combinations thereof serves as the acrylate component.

### Example 12

First, in a reflux system, 12.5 g of a suspension (Nissan; Model: MA-ST-M) which contained silica nanoparticles (present in an amount of 40 wt % based on 100 wt % of the suspension; average particle size: 25 nm) and methanol (serving as a dispersion medium) was diluted with 20 ml of methanol, followed by adding 2.5 g of 3-methacryloxypropyltrimethoxysilane (MPS, a monoacryloyl alkoxysilane serving as an acryloyl alkoxysilane) (ACROS; purity: 98.0%). Based on a total amount of the silica nanoparticles and the MPS as 100 wt %, the silica nanoparticles were present in an amount of 66.7 wt %, and the MPS was present in an amount of 33.3 wt %. Subsequently, the silica nanoparticles were subjected to a surface modification treatment with the MPS at 50° C. for 24 hours to allow the surfaces of the silica nanoparticles to be modified by the MPS, thereby obtaining a first composite additive including the modified silica nanoparticles (serving as an organic-inorganic composite material) and the methanol.

Next, a polymerization product was prepared according to the procedures as described in Example 1. After that, the polymerization product (including a cross-linked polymer and ethyl acetate) was mixed with an acrylate component and the first composite additive, so as to obtain a raw material. The acrylate component included HDDA (a diacrylate monomer) and 12FHA (a monoacrylate monomer). The raw material and a photoinitiator (Ciba-Geigy; Model: Irgacure 184) were then mixed in a weight ratio of 100:4, followed by an air-drying treatment for 2 days, so as to remove most of the ethyl acetate and the methanol, and then the air exhauster was used to remove remainder of the ethyl acetate and the methanol, thereby obtaining an encapsulant. In the encapsulant, based on a total amount of the cross-linked polymer, the acrylate component, and the modified silica nanoparticles as 100 wt %, the cross-linked polymer was present in an amount of 21.8 wt %, the acrylate component was present in an amount of 51 wt % (with the HDDA accounting for 43.7 wt % and the 12FHA accounting for 7.3 wt %), and the modified silica nanoparticles were present in an amount of 27.2 wt %. The encapsulant was stored in a sample bottle wrapped with an aluminum foil for later use. Thereafter, an encapsulation film was prepared according to the procedures as described in Example 1.

### Examples 13 to 18

The procedures for preparing an encapsulation film of each of Examples 13 to 18 were similar to those of Example 12, except that the amount of the cross-linked polymer, the type and amount of the acrylate component, the amount of the modified silica nanoparticles, and the amount of silica nanoparticles and MPS used for preparing the modified silica nanoparticles were varied as shown in Tables 3 and 4, and Table A below.

### Example 19

First, in a reflux system, 5 g of MPS was mixed with 20 ml of methanol, followed by subjecting the MPS to a hydrolysis-condensation reaction at 50° C. for 24 hours to form acryloyl silica particles, thereby obtaining a second composite additive including the acryloyl silica particles (serving as an organic-inorganic composite material) and the methanol.

Subsequently, a polymerization product was prepared according to the procedures as described in Example 1. After that, the polymerization product (including a cross-linked polymer and ethyl acetate) was mixed with an acrylate component and the second composite additive, so as to obtain a raw material. The acrylate component included NPGDA (a diacrylate monomer). The raw material and a photoinitiator (Ciba-Geigy; Model: Irgacure 184) were then mixed in a weight ratio of 100:4, followed by an air-drying treatment for 2 days, so as to remove most of the ethyl acetate and the methanol, and then a vacuum pumping system with an air exhauster was used to remove remainder of the ethyl acetate and the methanol, thereby obtaining an encapsulant. In the encapsulant, based on a total amount of the cross-linked polymer, the acrylate component, and the acryloyl silica particles as 100 wt %, the cross-linked polymer was present in an amount of 22.5 wt %, the acrylate component was present in an amount of 29.9 wt %, and the acryloyl silica particles were present in an amount of 47.6 wt %. The encapsulant was stored in a sample bottle wrapped with an aluminum foil for later use. Thereafter, an encapsulation film was prepared according to the procedures as described in Example 1.

### Examples 20 to 21

The procedures for preparing an encapsulation film of each of Examples 20 and 21 were similar to those of Example 19, except that the type and amount of the acrylate component were varied as shown in Table 4 below.

### Property Evaluation

### Fourier-Transform Infrared (FTIR) Spectroscopy Analysis

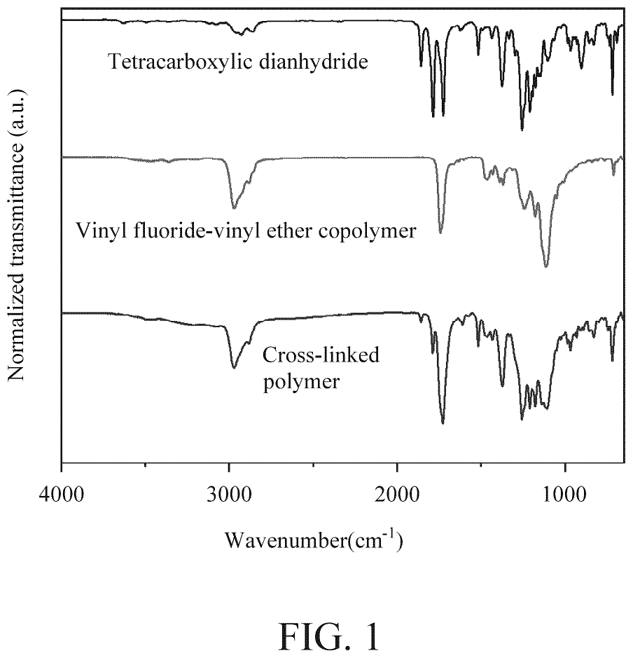

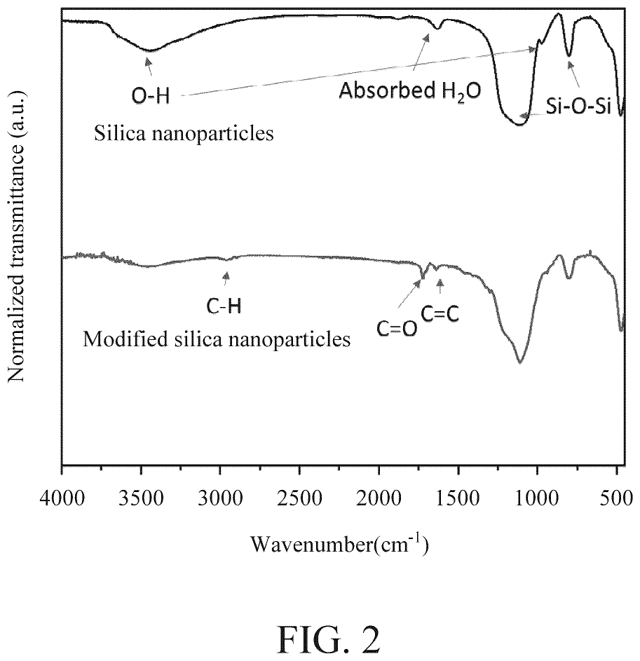

A respective one of the vinyl fluoride-vinyl ether copolymer and the FIDA (serving as the tetracarboxylic dianhydride) of Example 1, in suitable amounts thereof, and the cross-linked polymer, in suitable amount thereof, prepared in Example 1 was subjected to FTIR spectroscopy analysis using an FTIR spectrometer (PerkinElmer; Model: Spectrum 100). FTIR spectra were collected over a wavenumber ranging from 4000 cm⁻¹ to 600 cm⁻¹ at a resolution of 1 cm⁻¹. The results are shown in FIG. 1. In addition, a respective one of the silica nanoparticles of Example 12 and the modified silica nanoparticles prepared in Example 12, in suitable amounts thereof, was subjected to FTIR spectroscopy analysis using the FTIR spectrometer. FTIR spectra were collected over a wavenumber ranging from 4000 cm⁻¹ to 600 cm⁻¹ at a resolution of 1 cm⁻¹. The results are shown in FIG. 2.

Referring to FIG. 1, the cross-linked polymer had a characteristic peak of COOH functional groups at a wavenumber of 3200 cm⁻¹, indicating that the vinyl fluoride-vinyl ether copolymer and the tetracarboxylic dianhydride (i.e., the FIDA) were indeed cross-linked to form the cross-linked polymer. Referring to FIG. 2, the modified silica nanoparticles had a characteristic peak of C═C functional groups at a wavenumber of 1638 cm⁻¹, and a characteristic peak of C═O functional groups at a wavenumber of 1722 cm⁻¹, indicating that the MPS was indeed capable of modifying the surfaces of the silica nanoparticles to form the modified silica nanoparticles.

Observation of Whether Encapsulant Reacts with Perovskite Layer

First, each of indium-tin-oxide (ITO) glasses (FrontMaterials; Model: 10-15Ω/□) was ultrasonically cleaned sequentially with acetone, methanol, and isopropanol using an ultrasonic cleaning machine (KUDOS; Model: SK5210HP). After that, a surface of the ITO glass was subjected to a spin-coating treatment using a spin coater (Laurell Technologies; Model: WS-650-23), so as to spin-coat a nickel oxide sol-gel solution onto the surface of the ITO glass at a speed of 2500 rpm for 60 seconds, followed by an annealing treatment in an air atmosphere at 160° C. for 30 minutes, so as to form a nickel oxide layer on the surface of the ITO glass. Next, a perovskite layer was coated on a surface of the nickel oxide layer opposite to the ITO glass as follows. Methylammonium iodide and lead iodide were mixed at a molar ratio of 1:1 in a solvent (containing 0.8 mL of dimethylformamide and 0.2 mL of dimethylstyrene), so as to form a perovskite precursor solution. After that, the surface of the nickel oxide layer was subjected to a spin-coating treatment using the spin coater, so as to spin-coat the perovskite precursor solution onto the surface of the nickel oxide layer in a nitrogen atmosphere and at a speed of 4500 rpm for 30 seconds, followed by using diethyl ether to wash away an exceeding amount of the solvent, thereby forming a perovskite precursor layer on the surface of the nickel oxide layer. Thereafter, the perovskite precursor layer coated on the surface of the nickel oxide layer was subjected to a first annealing treatment at 70° C. for 30 seconds, and then to a second annealing treatment at 100° C. for 2 minutes, thereby forming a perovskite layer including a perovskite phase.

Subsequently, in a glove box, each of the encapsulant obtained in Examples 1 to 21 was coated on a surface of the perovskite layer of a respective one of the ITO glasses, followed by observing whether or not the color of the perovskite layer changed within 24 hours. If the encapsulant reacted with the perovskite layer, the color of the perovskite layer would turn yellow or transparent (if the encapsulant did not react with the perovskite layer, the color of the perovskite layer appeared purple-black). The results are shown in Tables 1 to 4 below.

### Determination of Water-Vapor Permeability (WVP)

Determination of a WVP value of the encapsulation film of each of Examples 1 to 21 was carried out in accordance with the American Society for Testing and Materials (ASTM) E96 standard as follows. First, a container filled with water was covered with the encapsulation film having an area (size) of 10 cm², followed by placing the container in a desiccator (AS ONE; Model: RVD300) with a temperature and a relative humidity (RH) maintained at 23° C. and 5%, respectively. The container was then subjected to weight measurement using an electronic balance (Precisa; Model: XS 245A-SCS) every day for a 7-day test period, so as to determine a weight of the water that was lost after evaporation (i.e., the weight of the water that had been evaporated into water vapor). After that, the WVP value of the encapsulation film was calculated using the following Equation (1):

$$WVP value = m \times d / A \times t \qquad ( 1 )$$

where m=weight of water that was lost after evaporation (g)
   d=thickness of encapsulation film (mm)
   A=area of encapsulation film (m²)
   t=number of day(s) of weight measurement (day(s))

The results are shown in Tables 1 to 4 below.

### Measurement of Visible Light Transmittance

Initially, two tapes, each having a thickness of 50 μm, were pasted on a quartz substrate in a parallel manner and spaced apart from each other by 1.5 cm, and then the encapsulant of each of Examples 1 to 21 was dropped on the quartz substrate between the two tapes, followed by using a PET film to cover the two tapes and the encapsulant on the quartz substrate. Thereafter, a glass rod was used to press across the PET film, so that an excess amount of the encapsulant was squeezed out of the quartz substrate. Subsequently, the encapsulant on the quartz substrate was subjected to a photo-curing reaction using a high-power ultraviolet lamp (OPAS, Model: Xlite 400Q) for 2 minutes, so that the encapsulant was formed into an encapsulation film which was attached to the quartz substrate, followed by removing the PET film. Next, the encapsulation film attached to the quartz substrate was subjected to measurement of visible light transmittance at a wavelength ranging from 250 nm to 800 nm using an ultraviolet/visible light (UV-Vis) spectrometer (JASCO; Model: V-650). The results are shown in Tables 1 to 4.

### Accelerated Life Testing

First, a perovskite layer including a perovskite phase was formed on each of ITO glasses (FrontMaterials; Model: 10-15Ω/□) according to the procedures as described in the section “Observation of whether encapsulant reacts with perovskite layer” above. Subsequently, the encapsulant of Example 19 was coated on a surface of the perovskite layer opposite to the nickel oxide layer, followed by covering a piece of glass on a surface of the encapsulant of Example 19. Next, the encapsulant of Example 19 coated on the surface of the perovskite layer was subjected to a photo-curing reaction using a UV-A lamp (ANALYTIK JENA; Model: UVLMS-38) with light having a power of 1.5 W and a wavelength of 365 nm, so that the encapsulant was formed into an encapsulation film, thereby obtaining a perovskite solar cell including the encapsulation film. The perovskite solar cell was then subjected to an accelerated life testing by placing such perovskite solar cell in an oven (Terchy; Model: HRMB-80) with a temperature and relative humidity (RH) maintained at 65° C. and 65%, respectively, for a 400-hour test period. During the accelerated life testing, a solar simulator (Newport; Model: LSH-7320) was used to provide illumination approximating natural sunlight and a power meter (Keithley; Model: 2410) was used to test the efficiency of the perovskite solar cell at different test times over the 400-hour test period. The normalized efficiency of the perovskite solar cell at different test times after the accelerated life testing was calculated using the following Equation (2):

$$E = F / G \qquad ( 2 )$$

where E=normalized efficiency of the perovskite solar cell
   F=efficiency of the perovskite solar cell measured at different test times after the accelerated life testing
   G=efficiency of the perovskite solar cell measured on the 0th hour after the accelerated life testing

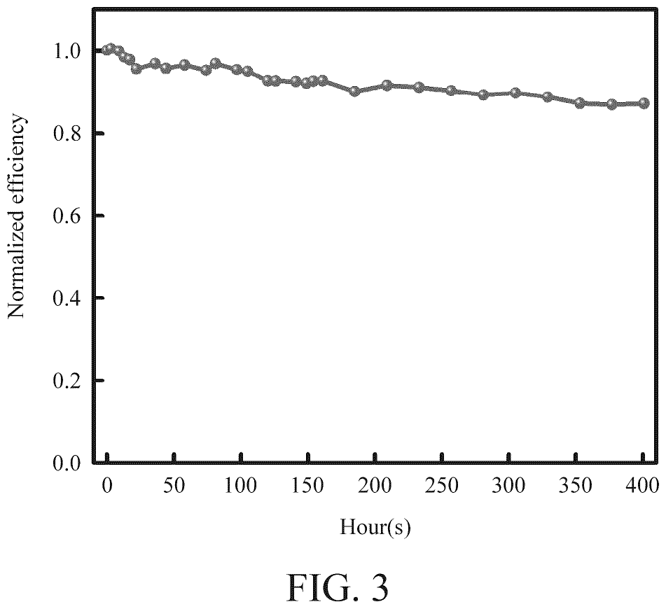

The results are shown in FIG. 3. If the normalized efficiency of the perovskite solar cell calculated is not lower than 0.6, the perovskite solar cell is considered usable. If the normalized efficiency of the perovskite solar cell calculated is lower than 0.6, the perovskite solar cell is considered unusable. If the normalized efficiency of the perovskite solar cell calculated on the 400th hour after the accelerated life testing is not lower than 0.8, the perovskite solar cell is considered to have excellent lifespan.

TABLE 1

| | | Example | | | | | |
|---|---|---|---|---|---|---|---|
| | | 1 | 2 | 3 | 4 | 5 | 6 |
| Cross-linked polymer | | 30 | 30 | 30 | 30 | 30 | 30 |
| (wt %) | | | | | | | |
| Acrylate | NPGDA | 70 | 0 | 0 | 0 | 0 | 52.5 |
| component | (wt %) | | | | | | |
| | HDDA | 0 | 70 | 65 | 60 | 50 | 17.5 |
| | (wt %) | | | | | | |
| | 12FHA | 0 | 0 | 5 | 10 | 20 | 0 |
| | (wt %) | | | | | | |

| Whether encapsulant | No | | | | | |
|---|---|---|---|---|---|---|
| reacts with perovskite | | | | | | |
| layer | | | | | | |
| WVP value | 1.67 | 2.08 | 1.69 | 1.21 | 2.14 | 1.26 |
| (g × mm/m² × number of | | | | | | |
| day(s)) | | | | | | |
| Visible light transmittance | 96.9 | 96 | 95.6 | 93.7 | 91.4 | 94.2 |
| (%) | | | | | | |

TABLE 2

| | | Example | | | | |
|---|---|---|---|---|---|---|
| | | 7 | 8 | 9 | 10 | 11 |
| Cross-linked polymer | | 30 | 30 | 30 | 30 | 30 |
| (wt %) | | | | | | |
| Acrylate | NPGDA | 35 | 17.5 | 65 | 60 | 50 |
| component | (wt %) | | | | | |
| | HDDA | 35 | 52.5 | 0 | 0 | 0 |
| | (wt %) | | | | | |
| | 12FHA | 0 | 0 | 5 | 10 | 20 |
| | (wt %) | | | | | |

| Whether encapsulant reacts | No | | | | |
|---|---|---|---|---|---|
| with perovskite layer | | | | | |
| WVP value | 1.89 | 1.86 | 2.43 | 2.69 | 2.82 |
| (g × mm/m² × number of | | | | | |
| day(s)) | | | | | |
| Visible light transmittance | 97.5 | 96.9 | 96.4 | 96.6 | 96.0 |
| (%) | | | | | |

TABLE 3

| | | Example | | | | |
|---|---|---|---|---|---|---|
| | | 12 | 13 | 14 | 15 | 16 |
| Cross-linked polymer | | 21.8 | 21.8 | 20.5 | 20.5 | 21.7 |
| (wt %) | | | | | | |
| Acrylate | NPGDA | 0 | 38.2 | 0 | 35.9 | 29.0 |
| component | (wt %) | | | | | |
| | HDDA | 43.7 | 12.8 | 41.0 | 12.0 | 0 |
| | (wt %) | | | | | |
| | 12FHA | 7.3 | 0 | 6.9 | 0 | 0 |
| | (wt %) | | | | | |
| Organic-inorganic | Modified silica | 27.2 | 27.2 | 31.6 | 31.6 | 49.3 |
| composite | nanoparticles | | | | | |
| material | (wt %) | | | | | |
| | Acryloyl silica | — | — | — | — | — |
| | particles | | | | | |
| | (wt %) | | | | | |

| Whether encapsulant | No | | | | |
|---|---|---|---|---|---|
| reacts with perovskite | | | | | |
| layer | | | | | |
| WVP value | 1.97 | 1.00 | 1.26 | 0.85 | 1.67 |
| (g × mm/m² × number of | | | | | |
| day(s)) | | | | | |
| Visible light transmittance | 54.4 | 58.8 | 75.0 | 87.1 | 89.4 |
| (%) | | | | | |

TABLE 4

| | | Example | | | | |
|---|---|---|---|---|---|---|
| | | 17 | 18 | 19 | 20 | 21 |
| Cross-linked polymer | | 21.7 | 21.7 | 22.5 | 22.5 | 22.5 |
| (wt %) | | | | | | |
| Acrylate | NPGDA | 0 | 21.8 | 29.9 | 0 | 22.4 |
| component | (wt %) | | | | | |
| | HDDA | 24.9 | 7.2 | 0 | 25.6 | 7.5 |
| | (wt %) | | | | | |
| | 12FHA | 4.1 | 0 | 0 | 4.3 | 0 |
| | (wt %) | | | | | |
| Organic-inorganic | Modified silica | 49.3 | 49.3 | — | — | — |
| composite | nanoparticles | | | | | |
| material | (wt %) | | | | | |
| | Acryloyl silica | — | — | 47.6 | 47.6 | 47.6 |
| | particles | | | | | |
| | (wt %) | | | | | |

| Whether encapsulant | No | | | | |
|---|---|---|---|---|---|
| reacts with perovskite | | | | | |
| layer | | | | | |
| WVP value | 1.01 | 1.14 | 2.09 | 1.80 | 1.31 |
| (g × mm/m² × number of | | | | | |
| day(s)) | | | | | |
| Visible light transmittance | 84.5 | 88.8 | 96.2 | 96.7 | 86.0 |
| (%) | | | | | |

TABLE A

| | | Example | | | | | | |
|---|---|---|---|---|---|---|---|---|
| | | 12 | 13 | 14 | 15 | 16 | 17 | 18 |
| Modified silica | Silica | 66.7 | 66.7 | 50 | 50 | 25 | 25 | 25 |
| nanoparticles | nanoparticles | | | | | | | |
| | (wt %) | | | | | | | |
| | MPS | 33.3 | 33.3 | 50 | 50 | 75 | 75 | 75 |
| | (wt %) | | | | | | | |

Referring to Tables 1 and 2, the encapsulant of each of Examples 1 to 11 did not react with the perovskite layer, and the encapsulation film of each of Examples 1 to 11 had the WVP value of not greater than 2.82 (g×mm/m²×number of day(s)), in which the WVP value determined in the encapsulation film of each of Examples 1 to 8 was even lower than 2.2 (g×mm/m²×number of day(s)). Moreover, the visible light transmittance of the encapsulation film of each of Examples 1 to 11 was higher than 90%, in which the visible light transmittance of the encapsulation film of each of Examples 1 to 3 and 7 to 11 was even higher than 95%. These results prove that not only the encapsulant according to the disclosure, which includes the cross-linked polymer and the acrylate component, does not react with the perovskite layer, but also the encapsulation film made from the encapsulant exhibits properties of low WVP and high visible light transmittance.

Referring to Tables 3 and 4, the encapsulant of each of Examples 12 to 21 did not react with the perovskite layer, and the encapsulation film of each of Examples 12 to 21 had the WVP value of not greater than 2.82 (g×mm/m²×number of day(s)), in particular, the WVP value was lower than 2.2 (g×mm/m²×number of day(s)). Moreover, the visible light transmittance of the encapsulation film of each of Examples 15 to 21 was higher than 80%, in which the visible light transmittance of the encapsulation film of each of Examples 19 and 20 was even higher than 95%. These results prove that not only the encapsulant according to the disclosure, which includes the cross-linked polymer, the acrylate component, and the organic-inorganic composite material, does not react with the perovskite layer, but also the encapsulation film made from the encapsulant exhibits properties of low WVP and high visible light transmittance.

Referring to FIG. 3, on the 400th hour after the accelerated life testing, the perovskite solar cell including the encapsulation film formed from the encapsulant of Example 19 still had a normalized efficiency of greater than 0.8, indicating that the encapsulation film formed from the encapsulant of Example 19 indeed enables the perovskite solar cell to have a long service life.

In sum, by inclusion of the cross-linked polymer and the acrylate component, the encapsulant according to the disclosure will not react with the perovskite layer, and the encapsulation film formed from the encapsulant has low WVP (WVP value is not greater than 2.82 (g×mm/m²×number of day(s))), which enables the perovskite solar cell including the encapsulation film to have a long serve life.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An encapsulant, comprising:
a cross-linked polymer formed by subjecting a vinyl fluoride-vinyl ether copolymer to a cross-linking reaction with a tetracarboxylic dianhydride, the vinyl fluoride-vinyl ether copolymer having a weight-average molecular weight ranging from 10000 to 50000, and a hydroxyl value ranging from 40 mg KOH/g to 170 mg KOH/g, the tetracarboxylic dianhydride being represented by formula (I) 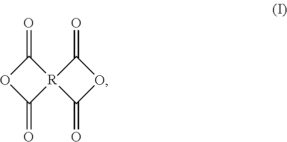
wherein R represents a tetravalent organic group containing fluorine and an aromatic group;
an acrylate component comprising an acrylate monomer selected from the group consisting of a monoacrylate monomer, a monomethacrylate monomer, a diacrylate monomer, a dimethacrylate monomer, a triacrylate monomer, a trimethacrylate monomer, and combinations thereof; and
a photoinitiator.

2. The encapsulant as claimed in claim 1, wherein the vinyl fluoride-vinyl ether copolymer is selected from the group consisting of a tetrafluoroethylene-vinyl ether copolymer, a chlorotrifluoroethylene-vinyl ether copolymer, and a combination thereof.

3. The encapsulant as claimed in claim 1, wherein the tetracarboxylic dianhydride is selected from the group consisting of a chemical compound represented by formula (II), 4,4′-(Hexafluoroisopropylidene)diphthalic anhydride, and a combination thereof,

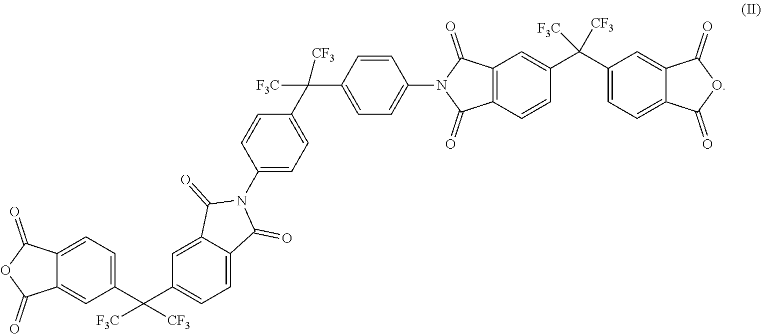 [SMILES: O=C1OC(=O)c2cc(C(c3ccc4c(c3)C(=O)N(c3ccc(C(c5ccc(N6C(=O)c7ccc(C(c8ccc9c(c8)C(=O)OC9=O)(C(F)(F)F)C(F)(F)F)cc7C6=O)cc5)(C(F)(F)F)C(F)(F)F)cc3)C4=O)(C(F)(F)F)C(F)(F)F)ccc21]

4. The encapsulant as claimed in claim 1, wherein the monoacrylate monomer is selected from the group consisting of 2-phenoxyethyl acrylate, 1H, 1H, 7H-dodecafluoroheptyl acrylate, and a combination thereof.

5. The encapsulant as claimed in claim 1, wherein the diacrylate monomer is selected from the group consisting of neopentyl glycol diacrylate, 1,6-hexanediol diacrylate, and a combination thereof.

6. The encapsulant as claimed in claim 1, wherein the triacrylate monomer is trimethylolpropane triacrylate.

7. The encapsulant as claimed in claim 1, wherein, based on a total amount of the cross-linked polymer and the acrylate component as 100 wt %, the cross-linked polymer is present in an amount ranging from 20 wt % to 80 wt %, and the acrylate component is present in an amount ranging from 20 wt % to 80 wt %.

8. The encapsulant as claimed in claim 1, further comprising an organic-inorganic composite material selected from the group consisting of modified silica nanoparticles, acryloyl silica particles, and a combination thereof.

9. The encapsulant as claimed in claim 8, wherein the modified silica nanoparticles are formed by subjecting silica nanoparticles to a surface modification treatment with an acryloyl alkoxysilane.

10. The encapsulant as claimed in claim 9, wherein the acryloyl alkoxysilane is selected from the group consisting of a monoacryloyl alkoxysilane, a monomethacryloyl alkoxysilane, a bisacryloyl alkoxysilane, a dimethacryloyl alkoxysilane, and combinations thereof.

11. The encapsulant as claimed in claim 8, wherein the acryloyl silica particles are formed by subjecting an acryloyl alkoxysilane to a hydrolysis-condensation reaction.

12. The encapsulant as claimed in claim 11, wherein the acryloyl alkoxysilane is selected from the group consisting of a monoacryloyl alkoxysilane, a monomethacryloyl alkoxysilane, a bisacryloyl alkoxysilane, a dimethacryloyl alkoxysilane, and combinations thereof.

13. The encapsulant as claimed in claim 8, wherein, based on a total amount of the cross-linked polymer, the acrylate component, and the organic-inorganic composite material as 100 wt %, the cross-linked polymer is present in an amount ranging from 20 wt % to 50 wt %, the acrylate component is present in an amount ranging from 20 wt % to 70 wt %, and the organic-inorganic composite material is present in an amount ranging from 10 wt % to 50 wt %.

14. An encapsulation film, which is formed by subjecting an encapsulant as claimed in claim 1 to a photo-curing reaction.
